(19) United States
(12) Patent Application Publication
(10) Pub. No.: US 2025/0382149 A1
(43) Pub. Date: Dec. 18, 2025

(54) HANDHELD GLASS FOILER AND METHOD OF USE

(71) Applicant: Michael Hacikyan, Naples, FL (US)

(72) Inventor: Michael Hacikyan, Naples, FL (US)

(21) Appl. No.: 18/746,531

(22) Filed: Jun. 18, 2024

(51) Int. Cl. B65H 35/00

(52) U.S. Cl. CPC B65H 35/0086; B65H 35/002

(57) ABSTRACT

A handheld glass foiler apparatus includes a housing containing a roll of metallic foil material. A foil dispenser, a glass alignment guide and a foil crimper are disposed on the housing. The foil dispenser includes a foil-dispensing roller and the glass alignment guide and foil crimper include respective slots. The foil-dispensing roller accommodates a characteristic range of foil widths, and the slots accommodate a characteristic range of glass thicknesses. A foil cutter includes a slidable thumb-engaging member that drives a foil cutting blade into engagement with the metallic foil after it dispenses from the foil dispenser. An adjustable foil holder is configured to hold the roll of flexible metallic foil material. A foil material backing peeler separates an adhesive backing from the foil material and directs the adhesive backing along a waste track to a waste exit of the housing.

### BACKGROUND

### 1. Field

The present invention relates generally to glass foiling. More particularly, the invention concerns a glass foiler for use by hobbyists in the fabrication of glass artwork and decorative glass products.

### 2. Description of the Prior Art

By way of background, glass foiler apparatus are used to apply a thin strip of metallic foil around the edges of a piece of glass so that it can be soldered to other glass pieces in order to fabricate glass artwork or decorative glass products. The foil strip, which is typically copper, has adhesive on one side for adhering the foil to the glass. The proper foil width for a given piece of glass is one that provides enough foil to completely cover the glass edge and also wrap around onto each side of the glass to thereby crimp the foil. The amount by which the foil wraps around sides of the glass can be varied according to how much solder is to be applied. During application of the foil strip, the foil is adhered along the glass edge with the strip centered thereon. The sides of the foil strip that overhang the glass edge are folded over and adhered to each side of the glass. The glass may then be soldered to one or more other glass pieces as desired.

It is to improvements in the design and use of glass foiler apparatus that the presently disclosed subject matter is directed.

### SUMMARY

A handheld glass foiler apparatus as disclosed herein includes a housing sized to be held by a human hand. The housing has a thumb-receiving edge portion arranged to engage a thumb of the human hand, and a finger-receiving edge portion arranged to engage the remaining fingers of the human hand. In an embodiment, the thumb-receiving edge portion and the finger-receiving edge portion may converge toward each other to a foil-dispensing portion of the housing. A roll of flexible metallic foil material is mounted on a hub within the housing.

A foil dispenser, a glass alignment guide and a foil crimper are disposed on the foil-dispensing portion of the housing. In an embodiment, the foil dispenser, the glass alignment guide and the foil crimper may be provided as a dispenser-guide-crimper assembly that is removably attached as a unit to the foil-dispensing portion of the housing.

The foil dispenser is configured to dispense the metallic foil material. The foil dispenser includes a foil-dispensing roller having a characteristic dispenser width corresponding to a characteristic width of the foil material.

The glass alignment guide is configured to slidably engage a glass edge as the metallic foil material dispensed from the foil dispenser is being applied to the edge. The glass alignment guide includes a slot having a characteristic slot width that accommodates a characteristic range of glass thicknesses.

The foil crimper is configured to slidably engage a glass edge to which the metallic foil has been applied and crimp the metallic foil so that it wraps around the glass edge onto adjacent major surfaces of the glass. The foil crimper includes a slot having a characteristic width that accommodates a characteristic range of glass thicknesses.

A foil cutter includes a slidable thumb-engaging member on the thumb-engaging edge portion of the housing, and a cutting element operably connected to the thumb-engaging member so as to be drivable thereby from a retracted position to an extended position wherein the cutting element engages the metallic foil as it dispenses from the foil dispenser.

An adjustable foil holder within the housing is configured to hold the roll of metallic foil material. The foil holder is adjustable to hold different rolls of metallic foil material having different foil widths.

A foil material backing peeler separates an adhesive backing from the foil material within the housing and directs the adhesive backing along a waste track to a waste exit of the housing.

In another aspect, a glass foiling method is disclosed for using a handheld-glass foiler apparatus as summarized above. The method includes grasping the glass foiler apparatus by placing a thumb on the thumb-receiving edge portion of the housing and the remaining fingers on the finger-receiving edge portion of the housing. The glass edge is inserted into the glass alignment guide. An end of the metallic foil material that extends from the foil dispenser is placed onto the glass edge. The glass alignment guide and the glass edge are slid relative to each other so that additional metallic foil material is dispensed from the foil dispenser and onto the glass edge. When a desired amount of the glass edge is covered with the metallic foil material, the metallic foil is cut by advancing the slidable thumb-engaging member of the foil cutter to drive the cutting element to its extended position. The metallic foil material is crimped by placing the glass edge that is covered with the metallic foil material into the foil crimper and sliding the crimper and the glass edge relative to each other.

### BRIEF DESCRIPTION OF THE DRAWINGS

The foregoing and other features and advantages will be apparent from the following more particular description of example embodiments, as illustrated in the accompanying Drawings, in which:

FIG. 1 is a perspective view showing an example embodiment of a handheld glass foiler apparatus that may be constructed accordance with the present disclosure.

FIG. 2 is a side view of the foiler apparatus of FIG. 1.

FIG. 3 is a front view of the foiler apparatus of FIG. 1.

FIG. 4 is a rear view of the foiler apparatus of FIG. 1.

FIG. 5 is a top view of the foiler apparatus of FIG. 1.

FIG. 6 is a bottom view of the foiler apparatus of FIG. 1.

FIG. 7 is an exploded perspective view of the foiler apparatus of FIG. 1 showing internal components thereof.

FIG. 8 is a further exploded perspective view of the foiler apparatus of FIG. 1 showing further internal components thereof.

FIG. 9 is a further exploded perspective view of the foiler apparatus of FIG. 1 showing further internal components thereof.

FIG. 10 is a further exploded perspective view of the foiler apparatus of FIG. 1 showing further internal components thereof.

FIG. 11 is a further exploded perspective view of the foiler apparatus of FIG. 1 showing further internal components thereof.

FIG. 12 is a perspective view showing an example dispenser-guide-crimper assembly of the foiler apparatus of FIG. 1.

FIG. 13 is a perspective view of the foiler apparatus of FIG. 1 with the dispenser-guide-crimper assembly of FIG. 12 detached therefrom.

FIG. 14 is a perspective view of a first housing shell section of the foiler apparatus of FIG. 1 with the dispenser-guide-crimper assembly of FIG. 12 attached thereto.

FIG. 15 is a perspective view of a first housing shell section of the foiler apparatus of FIG. 1 with the dispenser-guide-crimper assembly of FIG. 12 detached therefrom.

FIG. 16 is another perspective view of a first housing shell section of the foiler apparatus of FIG. 1 with the dispenser-guide-crimper assembly of FIG. 12 detached therefrom.

FIG. 17 is a perspective view of a second housing shell section of the foiler apparatus of FIG. 1 with the dispenser-guide-crimper assembly of FIG. 12 attached thereto.

FIG. 18 is a perspective view of a second housing shell section of the foiler apparatus of FIG. 1 with the dispenser-guide-crimper assembly of FIG. 12 detached therefrom.

FIG. 19 is another perspective view of a second housing shell section of the foiler apparatus of FIG. 1 with the dispenser-guide-crimper assembly of FIG. 12 detached therefrom.

FIG. 20 is a front elevation view of the dispenser-guide-crimper assembly of FIG. 12.

FIG. 21 is a top plan view of the dispenser-guide-crimper assembly of FIG. 12.

FIG. 22A is a perspective view the dispenser-guide-crimper assembly of FIG. 12 sized to dispense metallic foil material having a first width.

FIG. 22B is a perspective view the dispenser-guide-crimper assembly of FIG. 12 sized to dispense metallic foil material having a second width.

FIG. 22C is a perspective view the dispenser-guide-crimper assembly of FIG. 12 sized to dispense metallic foil material having a third width.

FIG. 23 is a perspective view of a first housing shell section of the foiler apparatus of FIG. 1 with a foil-cutter assembly attached thereto.

FIG. 24 is a perspective view of a first housing shell section of the foiler apparatus of FIG. 1 with a foil-cutter assembly in an initial state of disassembly.

FIG. 25 is a perspective view of a first housing shell section of the foiler apparatus of FIG. 1 with a foil-cutter assembly in a further state of disassembly.

FIG. 26 is a perspective view of a first housing shell section of the foiler apparatus of FIG. 1 with a foil-cutter assembly in a further state of disassembly.

FIG. 27 is a perspective view of a first housing shell section of the foiler apparatus of FIG. 1 with a foil-cutter assembly in a further state of disassembly.

FIG. 28 is a perspective view of a first housing shell section of the foiler apparatus of FIG. 1 with a foil-cutter assembly in a further state of disassembly.

FIG. 29 is a plan view of a first housing shell section of the foiler apparatus of FIG. 1 during a first stage of a foiling operation.

FIG. 30 is a plan view of a first housing shell section of the foiler apparatus of FIG. 1 during a second stage of a foiling operation.

FIG. 31 is a perspective view of a first housing shell section of the foiler apparatus of FIG. 1 with a foil holding set disk thereof engaging a roll of foil material.

FIG. 32 is a perspective view of a first housing shell section of the foiler apparatus of FIG. 1 with a foil holding set disk thereof disengaged from a roll of foil material.

FIG. 33 is a further perspective view of a first housing shell section of the foiler apparatus of FIG. 1 with a foil holding set disk thereof disengaged from a roll of foil material.

FIG. 34 is a plan view of a first housing shell section of the foiler apparatus of FIG. 1 with a foil holding set disk thereof engaging a roll of foil material having a first foil width.

FIG. 35 is a plan view of a first housing shell section of the foiler apparatus of FIG. 1 with a foil holding set disk thereof engaging a roll of foil material having a second foil width.

FIG. 36 is a plan view of a first housing shell section of the foiler apparatus of FIG. 1 with a foil holding set disk thereof engaging a roll of foil material having a third foil width.

### DETAILED DESCRIPTION OF EXAMPLE EMBODIMENTS

Turning now to the drawing figures, which are not necessarily to scale, like reference numbers are used to represent like elements in all of the several views.

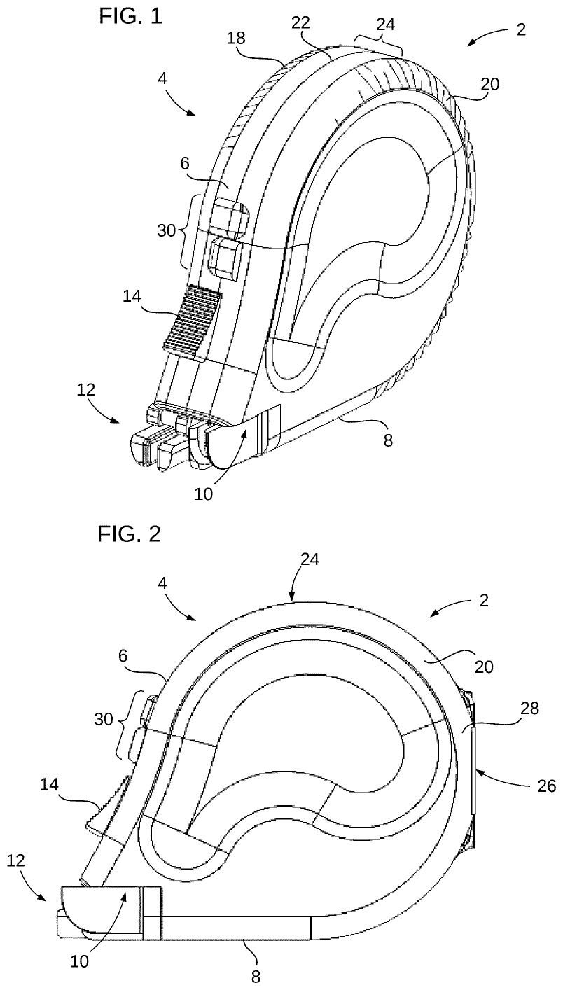

FIGS. 1-6 illustrate a handheld glass foiler apparatus 2 that may be constructed in accordance an example embodiment of the present disclosure. In this embodiment, the major structural components of the glass foiler apparatus 2 may be manufactured as (e.g., molded) plastics of suitable rigidity and strength, with certain individual components being formed from metal as may be required by their respective functions. Other embodiments could utilize other structural materials in lieu of plastics for the major structural components, such as metals or composites, depending on manufacturer preferences.

The foiler apparatus 2 includes a housing 4 that is sized to be held by an adult human hand. The housing 4 includes a thumb-receiving edge portion 6 arranged to engage a thumb of the hand, and a finger-receiving edge portion 8 arranged to engage the remaining fingers of the hand. The thumb-receiving edge portion 6 and the finger-receiving edge portion 8 converge toward each other to a foil-dispensing portion 10 of the housing 4. As described in more detail below, the foil-dispensing portion 10 mounts a dispenser-guide-crimper assembly 12 from which metallic foil is dispensed from inside the housing 4.

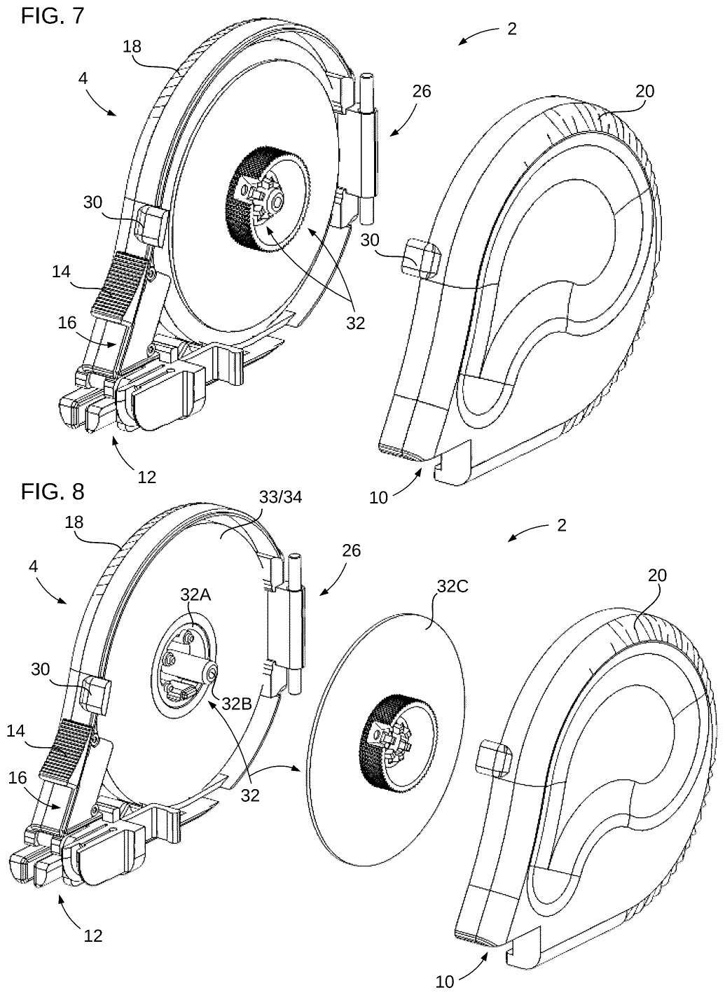

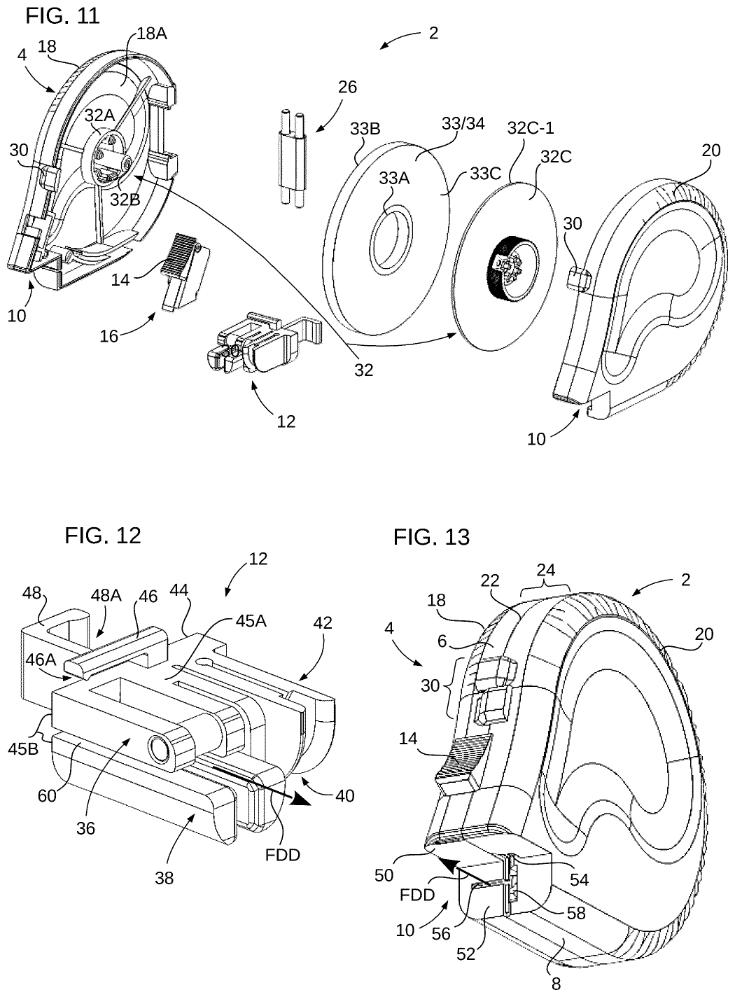

A slidable thumb-engaging member 14 is disposed on the thumb-receiving edge portion 6. As described in more detail below, the thumb-engaging member 14 is part of a foil cutter assembly 16 (see FIGS. 7-11) that can be manipulated by a user's thumb in order to cut the metallic foil dispensed from the dispenser-guide-crimper assembly 12 following application of a length thereof to the edge of a glass piece (not shown in FIGS. 1-6).

The housing 4 may be formed as a shell structure that includes a first (lower) housing shell section 18 and a second (upper) housing shell section 20 joined at a part line 22. The part line 22 extends around a main edge 24 of the housing that includes the thumb-receiving edge portion 6 and the finger-receiving edge portion 8. As best shown in FIG. 5, the lower housing shell section 18 and the upper housing shell section 20 are respectively situated on the right side and left sides of the housing 4 when the foiler apparatus 2 is viewed from above the thumb-engaging edge portion 6.

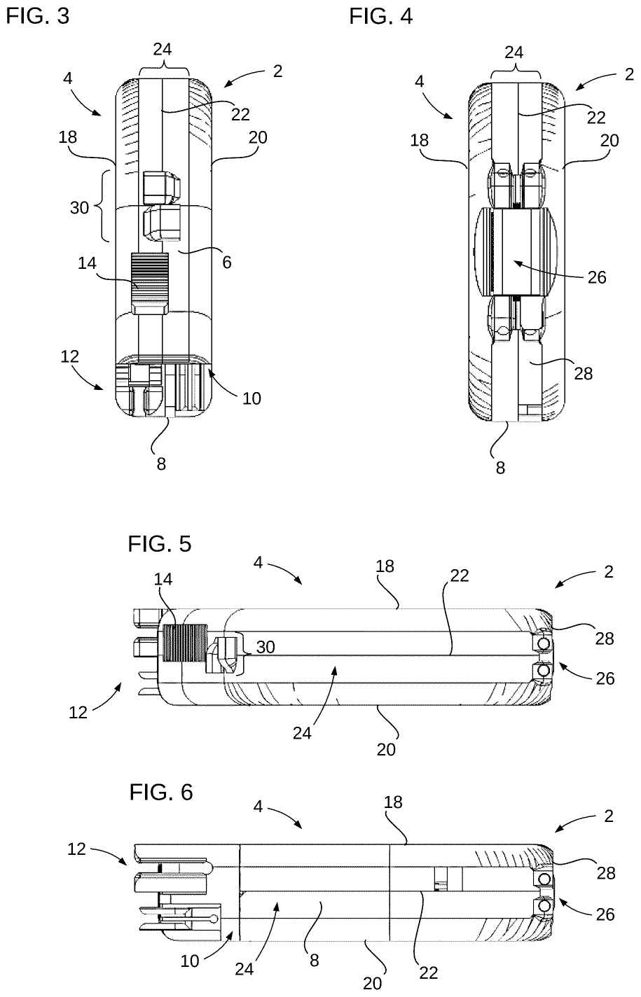

When the foiler apparatus 2 is held by a user with the user's thumb on the thumb-engaging edge portion 6 and the user's remaining fingers on the finger-engaging edge portion 8, the lower housing shell section 18 and the upper housing shell section 20 will engage one of the user's palms, depending on the hand (left or right) in which the foiler apparatus is held. Advantageously, the housing 4 is ergonomically sized and shaped for efficient single-handed operation. For example, the maximum height of the housing 4 (i.e., from top to bottom in FIG. 2) may range between approximately 3-4 inches. The maximum thickness of the housing 4 (i.e., from side to side in FIGS. 3-6) may range between approximately 1-1.2 inches. As previously noted, the thumb-receiving edge portion 6 and the finger-receiving edge portion 8 converge toward each other to provide a tapered shape that facilitates natural gripping between the thumb and fingers.

As best shown in FIGS. 2 and 4, the lower housing shell section 18 and the upper housing shell section 20 may be pivotally connected to each other by a hinge assembly 26 to facilitate opening and closing of the housing 4 to access an interior thereof. The hinge assembly 26 may be situated on a back-side edge portion 28 of the housing 4. A pair of clasps 30 may be provided on the thumb-engaging edge portion 6 to facilitate locking of the lower housing shell section 18 and the upper housing shell section 20 in their closed position following opening.

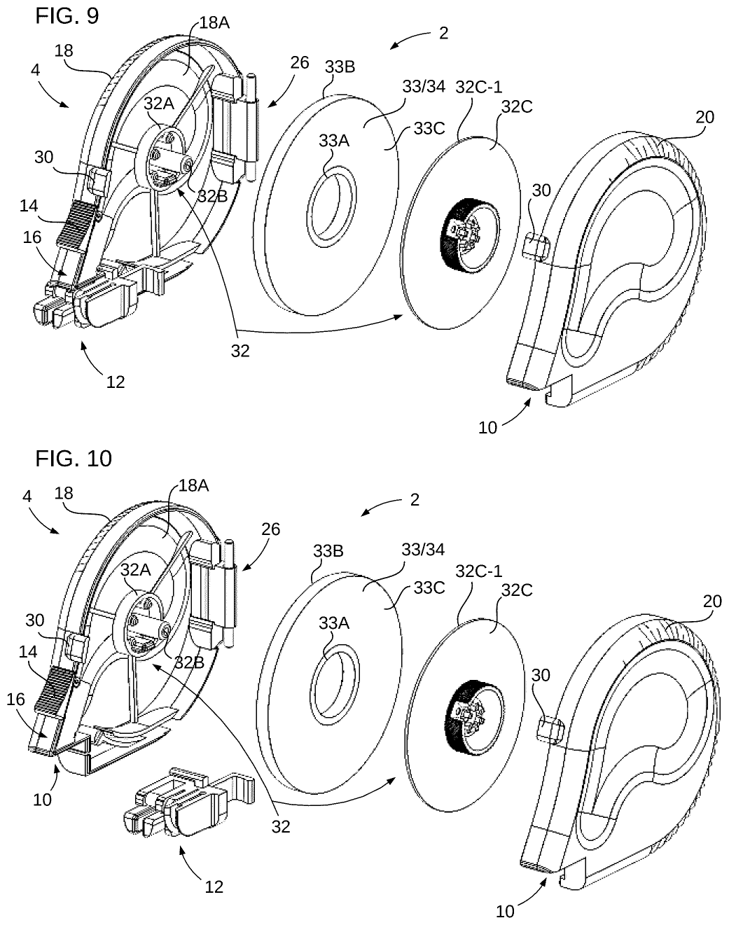

Turning now to FIGS. 7-11, the lower housing shell section 18 and the upper housing shell section 20 are separated to illustrate additional components of the foiler apparatus 2. For example, an adjustable foil holder assembly 32 within the housing 4 is configured to hold a roll 33 of flexible metallic foil material 34. As described in more detail below, the foil holder assembly 32 is adjustable to hold different rolls 33 of metallic foil material 34 having different foil widths. As can be seen in FIGS. 8-11, the foil holder assembly 32 may be implemented as a multi-component assembly that includes a roll-holding hub 32A, a spindle 32B, and a rotatably positionable set disk 32C. As can be seen in FIGS. 9-11, the roll-holding hub 32A extends from an inside surface 18A of the lower housing shell section 18. The roll-holding hub 32A engages a central core ring 33A in the roll 33 of metallic foil material 34, entering from a first (lower) side 33B of the roll. The spindle 32B extends from the same inside surface 18A of the lower housing shell section 18, concentrically with the roll-holding hub 32A, and passes through and beyond the central core ring 33A in the roll 33 of metallic foil material 28. The set disk 32C has a first (lower) face 32C-1 that engages a second (upper) side 33C of the roll 33 of metallic foil material 28.

FIGS. 7-11 also illustrate example constructions of the dispenser-guide-crimper assembly 12 and the foil cutter assembly 16 that includes the thumb-engaging member 14 mentioned above. An example construction of the hinge assembly 26 is also shown.

Turning now to FIG. 12-22C, an example construction of the dispenser-guide-crimper assembly 12 is shown. In FIG. 12, the dispenser-guide-crimper assembly 12 is shown to include a foil dispenser 36, a glass alignment guide 38, and a foil crimper 40. The foil dispenser 36, the glass alignment guide 38, and the foil crimper 40 are provided by a set of functional structures 42 that extend in a forward foil-dispensing direction (shown by arrow labeled “FDD”) of the foiler apparatus 2. The functional structures 42 extend from a dispenser-guide-crimper assembly backbone structure 44 that itself extends substantially orthogonal to the foil-dispensing direction 42. The functional structures 42 that define the foil dispenser 36, the foil crimper 40, and optionally the backbone structure 44, have coplanar upper surfaces that are horizontally oriented so as to collectively define a planar upper face 45A of the dispenser-guide-crimper assembly 12. The backbone structure 44 may be provided with a rear surface that is optionally planar and vertically oriented so as to define a planar rear face 45B of the dispenser-guide-crimper assembly 12.

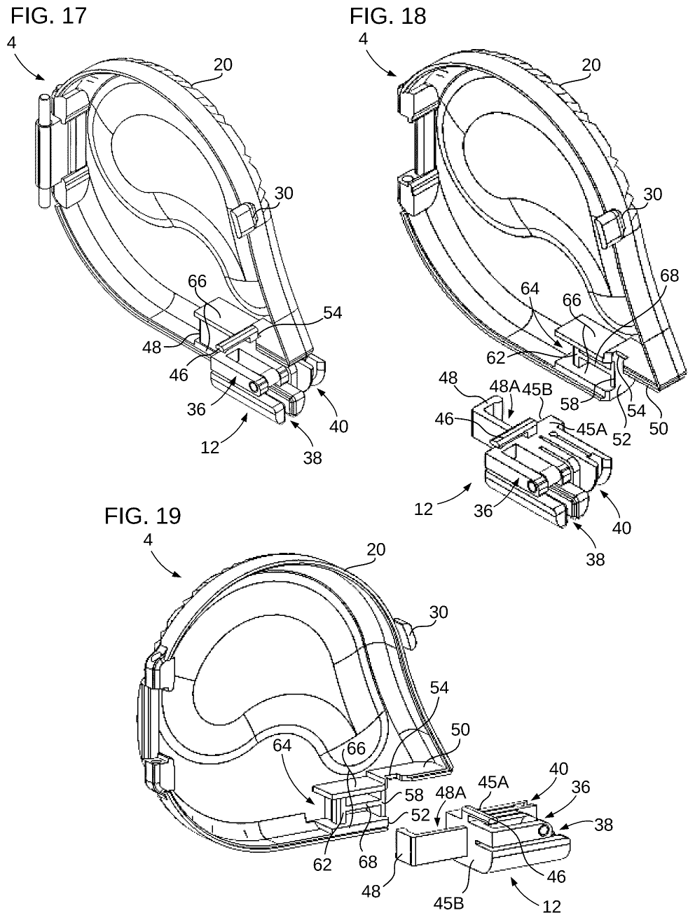

Extending parallel to the backbone structure 44, in spaced relation to the rear edge of the planar upper face 45A, is an upper latch 46 that provides a first attachment member for attaching the dispenser-guide-crimper assembly 12 to the lower housing shell section 18 (as described in connection with FIGS. 14-16 below). Also extending parallel to the backbone structure 44, in spaced relation to the planar rear face 45B, is a posterior connector hook 48 that provides a second attachment member for attaching the dispenser-guide-crimper assembly 12 to the upper housing shell section 20 (as described in connection with FIGS. 17-19 below). It will be seen in FIG. 12 that the upper latch 46 and the posterior connector hook 48 of the dispenser-guide-crimper assembly 12 represent transverse arms that extend substantially parallel to the backbone structure 44 in spaced relationship therewith. This forms first and second attachment channels 46A and 48A. As respectively shown in FIGS. 14-16 and 17-19, the first and second attachment channels 46A and 48A respectively engage the lower housing shell section 18 and the upper housing shell section 20, with the base of each attachment channel receiving and capturing lateral edge or face portions of the housing shell sections.

It will be appreciated that the illustrated upper latch 46 and the posterior connector hook 48 are merely examples of attachment members that may be provided on the dispenser-guide-crimper assembly 12 for engaging with the housing upper and lower housing shell sections 18 and 20. Different attachment members of different configuration may be used in alternative embodiments of the dispenser-guide-crimper assembly 12. Such alternative embodiments may also utilize more or fewer attachment members than the illustrated embodiment of the dispenser-guide-crimper assembly 12. Attachment members that are formed as channels instead of protrusion structures may also be provided on the dispenser-guide-crimper assembly 12, as a matter of design choice.

The dispenser-guide-crimper assembly 12 may be advantageously designed for removable attachment as a unit to the foil-dispensing portion 10 of the housing 4, without the use of fasteners or tools. There are many design alternatives that may be employed to achieve such removable attachment. The illustrated embodiment of the housing 4 represents one example design alternative in which the foil-dispensing portion 10 is configured to receivably engage and retain the illustrated embodiment of the dispenser-guide-crimper assembly 12, thereby accommodating the particular configuration of that embodiment, including its particular attachment structures (the upper latch 46 and the posterior connector hook 48).

As shown in FIG. 13, the foil-dispensing portion 10 may include a horizontal, forwardly-extending planar ledge 50 that intersects the thumb-engaging edge portion 6 in a horizontal plane, and a vertical, downwardly-extending planar ledge 52 that intersects the finger-engaging edge portion 8 in a vertical plane. In FIG. 13, the forward direction represents the same foil-dispensing direction “FDD” shown in FIG. 12.

A portion of the horizontal ledge 50 that is provided by the upper housing shell section 20 is formed with a short notch opening 54. The notch opening 54 begins at the part line 22 of the housing 4, and extends a short distance horizontally therefrom. As shown FIGS. 17-19, the notch opening 54 provides clearance for a short vertical base portion of the latch 46 of the dispenser-guide-crimper assembly 12. This allows the longer horizontal free-end portion of the latch 46 to extend inside the housing 2 and engage the lower housing shell section 18 in the manner shown in FIGS. 14-16. As illustrated in those figures, the elongated horizontal portion of the latch 46 engages an interior surface of the horizontal ledge 50. In this latching configuration, the planar upper face 45A of the dispenser-guide-crimper assembly 12 abuts against the exterior surface of the horizontal ledge 50, thereby capturing the ledge within the first attachment channel 46A of the dispenser-guide-crimper assembly 12. The planar rear face 45B of the dispenser-guide-crimper assembly abuts against the vertical ledge 52.

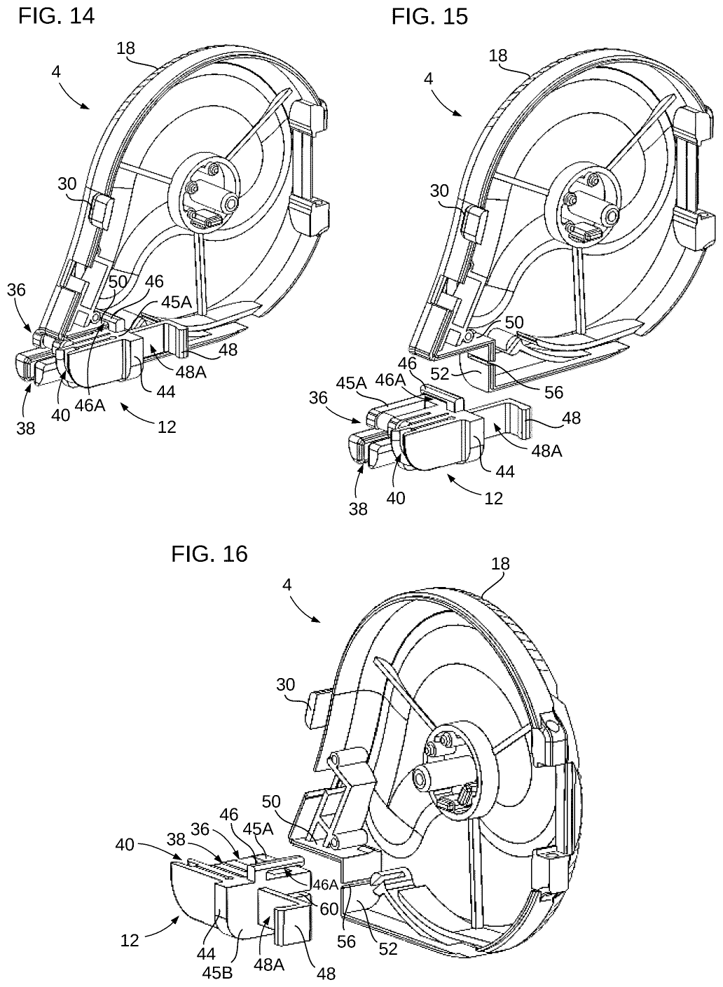

With continuing reference to FIG. 13, the vertical ledge 52 may be formed with two slots, one being a horizontal slot 56 and other being a vertical slot 58. The horizontal slot 56 is formed in the lower housing shell section 18, and represents a foil-dispensing exit of the housing 4. As shown in FIG. 16, the horizontal slot 56 aligns with a horizontal slot 60 that forms part of the foil dispenser 36 of the dispenser-guide-crimper assembly 12 (see FIG. 12).

Returning now to FIG. 13, the vertical slot 58 is formed in the upper housing shell section 20, and serves as a keyway that allows the posterior connector hook 48 of the dispenser-guide-crimper assembly 12 to extend into the housing 4. As previously noted, the connector hook 48 provides a second attachment member for attaching the dispenser-guide-crimper assembly 12 to the upper housing shell section 20.

This is shown in FIGS. 17-19. As illustrated in those figures, the posterior connector hook 48 of the dispenser-guide-crimper assembly 12 hooks onto an interior vertical flange 62 of the upper housing shell section 20. At the same time, the planar rear face 45B of the dispenser-guide-crimper assembly 12 abuts against the vertical ledge 52 of the upper housing shell section 20. In this connected configuration, the second attachment channel 48A of the dispenser-guide-crimper assembly 12 is captured within a channel 64 that includes upper and lower flanges 66 and a recessed lateral support surface 68 that includes exposed lateral faces of the vertical slot 58 and the vertical flange 62. The planar upper face 45A of the dispenser-guide-crimper assembly 12 abuts against the exterior surface of the horizontal ledge 50.

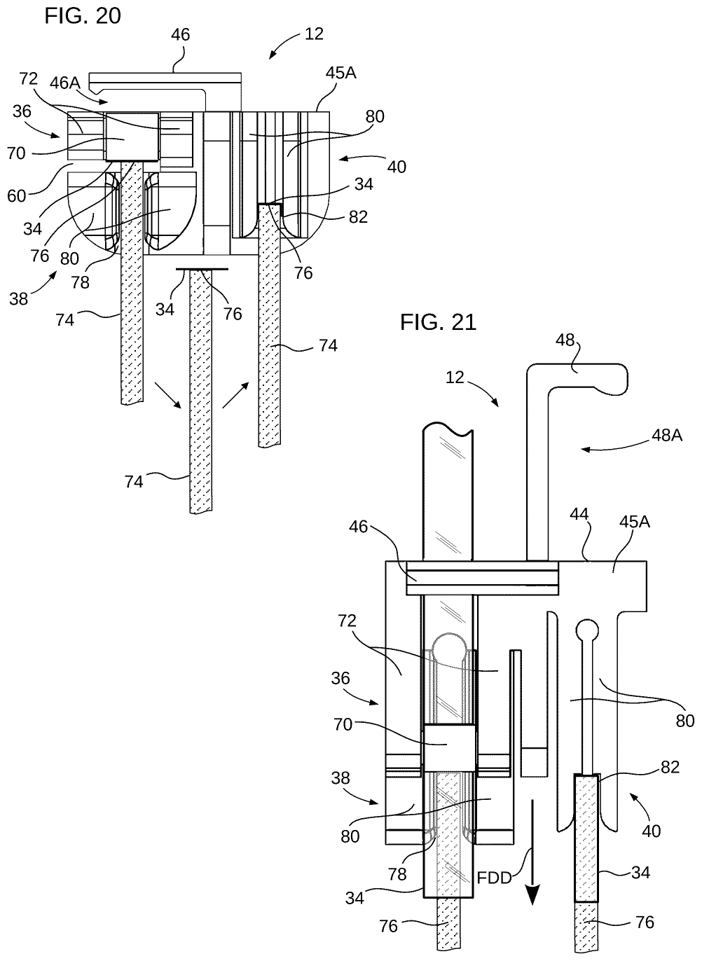

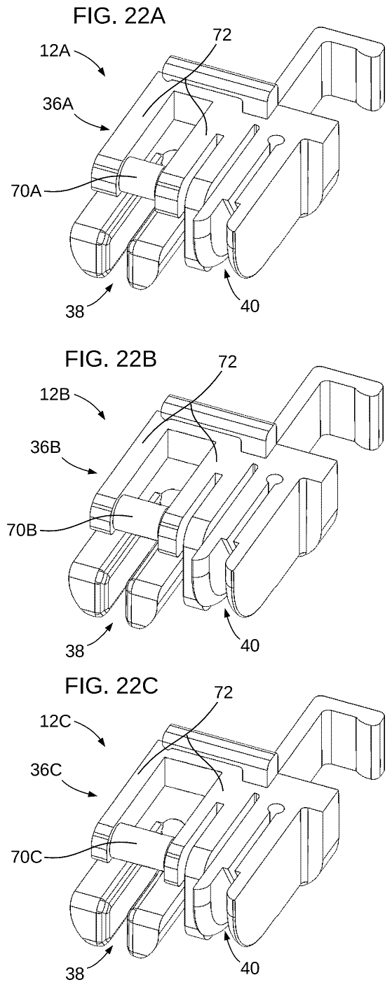

Turning now to FIGS. 20-21, the foil dispenser 36 of the dispenser-guide-crimper assembly 12 includes a foil-dispensing roller 70. As discussed in more detail below in connection with FIGS. 22A, 22B and 22C, the foil-dispensing roller 70 may have a characteristic length corresponding to a characteristic width of the roll of metallic foil material 34 disposed within the housing 4. The foil-dispensing roller 70 is supported by a pair of foil dispenser arms 72 that form part of the functional structures 42 that extend from the dispenser-guide-crimper assembly backbone structure 44 in the foil-dispensing direction “FDD.”

The glass alignment guide 38 of the dispenser-guide-crimper assembly 12 is situated below the foil dispenser 36. The glass alignment guide 38 is configured to slidably engage a sheet of glass 74 as the metallic foil material 34 dispensed from the foil dispenser 36 is being applied to the edge 76 of the glass. The glass alignment guide 38 includes an alignment slot 78 arranged to center the glass edge 76 with respect to the foil-dispensing roller 70 of the foil dispenser 36. The slot 78 is formed by a pair of alignment guide arms 80 that extend from the dispenser-guide-crimper assembly backbone structure 44 in the foil-dispensing direction “FDD.” The slot 78 has a characteristic slot width that accommodates a characteristic range of glass thicknesses (e.g., less than or equal to a nominal glass thickness for which the slot 78 is designed).

The foil dispenser 36 and the glass alignment guide 38 are designed to work in tandem with each other. The foil dispenser 36 centers the metallic foil material 34 with respect to the glass 74, and the glass alignment guide 38 centers the glass 74 with respect to the foil. During foiling operations, the user slides the glass 74 in between the alignment guide arms 80 of the glass alignment guide 38 and presses the glass against the foil-dispensing roller 70 of the foil dispenser 36. A non-adhesive side of the metallic foil 34 material rests on the underside of the foil-dispenser roller 70 while the adhesive side of the metallic foil material is pressed against the edge 76 of the glass 74.

The foil crimper 40 of the dispenser-guide-crimper assembly 12 is configured to slidably engage the glass edge 76 to which the metallic foil material 34 has been applied, and crimp the metallic foil so that it wraps evenly around the glass edge onto adjacent major surfaces (opposing sides) of the glass 74. Crimping occurs after the metallic foil material 34 has been applied to the glass edge 76, as shown by the left-hand piece of glass 74 in FIG. 20. The transition state between foiling and crimping is shown by the middle piece of glass 74 in FIG. 20. The crimped state that results from crimping is shown by the right-hand piece of glass 74 in FIG. 20. The foil crimper 40 includes a crimping slot 82 formed by a pair of crimper guide arms 84 that extend from the dispenser-guide-crimper assembly backbone structure 44 in the foil-dispensing direction “FDD.” The foil crimping slot 82 has a characteristic width that accommodates a characteristic range of glass thicknesses (e.g., less than or equal to a nominal glass thickness for which the slot 82 is designed). It will be seen that the foil crimping slot 82 is substantially parallel to the glass alignment guide slot 76.

As previously noted, the foil dispenser 36 of the dispenser-guide-crimper assembly 12 is sized and configured to dispense the metallic foil material from a selected one of a set of different rolls of metallic foil material 34, each having a different foil width. For example, rolls of copper foil may be provided in three widths: 3/16 in. (4.763 mm); 7/32 in. (5.556 mm); and ¼ in. (6.350 mm). In order to allow the foiler apparatus 2 to be used with the different magnetic foil rolls of different width, a set of interchangeable dispenser-guide-crimper assemblies 12 may be provided. Each dispenser-guide-crimper assembly 12 may have a characteristic foil dispenser 36 having a characteristic foil-dispensing roller 70 whose length substantially corresponds to the width of the metallic foil material 34, but provides sufficient clearance on either side of the foil material to prevent the foil from binding on the foil dispenser arms 72.

An example set of dispenser-guide-crimper assemblies 12 designed for different metallic foil widths is shown in FIGS. 22A, 22B and 22C. FIG. 22A depicts a first dispenser-guide-crimper assembly 12A having a foil dispenser 36A designed for a metallic foil material 34 of narrow width, such as 3/16 in. (4.763 mm) copper foil. To that end, the foil dispenser 36A may equipped with a relatively short-length foil-dispensing roller 70A. FIG. 22B depicts a second dispenser-guide-crimper assembly 12B having a foil dispenser 36B designed for a metallic foil material 34 of medium width, such as 7/32 in. (5.556 mm) copper foil. To that end, the foil dispenser 36B may equipped with a relatively medium-length foil-dispensing roller 70B. FIG. 22C depicts a third dispenser-guide-crimper assembly 12C having a foil dispenser 36C designed for a metallic foil material 34 of large width, such as ¼ in. (6.350 mm) copper foil. To that end, the foil dispenser 36C may equipped with a relatively long foil-dispensing roller 70C. In each of the dispenser-guide-crimper assemblies 12A, 12B and 12C, the foil dispenser arms 72 will have a characteristic spacing that accommodates the required length of the foil-dispensing roller 70A, 70B, and 70C, respectively.

In addition to providing a set of dispenser-guide-crimper assemblies 12 having different foil-dispensers 36 that accommodate metallic foils of different width, it will be appreciated that such dispenser-guide-crimper assemblies could also have different glass alignment guides 38 and crimpers 40 to accommodate pieces of glass 76 having different thicknesses. In that case, the alignment slots 78 of the different glass alignment guides 38, together with the crimping slots 82 of the foil crimpers 40, could have different slot spacings. In general, any given set of dispenser-guide-crimper assemblies 12 could have (1) different foil-dispensers 36 (for different metallic foil widths) but the same glass-alignment guide 38 and foil crimper 40 (for a single glass thickness), or (2) the same foil-dispenser 36 (for a single metallic foil width) but different glass-alignment guides 38 and foil crimpers 40 (for different glass thicknesses), or (3) both different foil-dispensers and different glass alignment guides and foil crimpers.

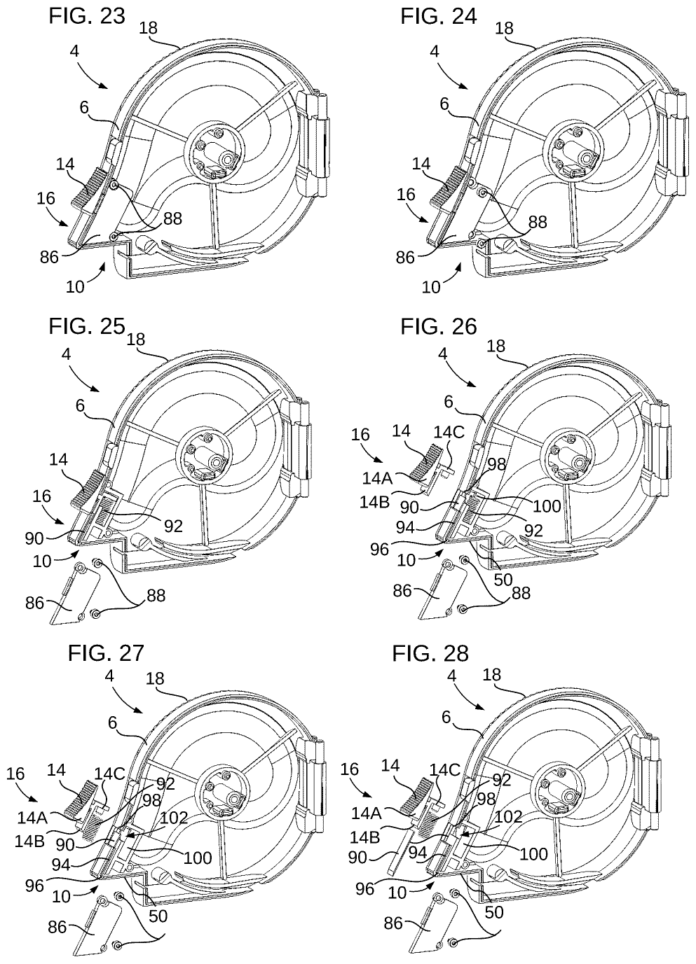

Turning now to FIGS. 23-28, an example construction of the foil cutter assembly 16 of the foiler apparatus 2 is shown. It will be appreciated that other constructions may be utilized in alternative embodiments. As previously mentioned, the foil cutter assembly 16 includes a slidable thumb-engaging member 14 on the thumb-engaging edge portion 6 of the housing 4. Although the thumb-engaging edge portion 6 of the housing 4 laterally spans both the lower housing shell section 18 and the upper housing shell section 20, the foil cutter assembly 16 is carried entirely by the lower housing shell section. FIGS. 23-28 thus depict only the lower housing shell section 18 with the upper housing shell section 20 removed.

FIG. 23 depicts the foil cutter assembly 16 completely mounted on the lower housing shell section 18. A foil cutter retention plate 86 may be used to retain the foil cutter assembly 16 in position. The retention plate 86 may be secured to the lower housing shell section 18 by a pair of fasteners 88, which may be implemented as machine screws. FIG. 24 depicts the foil cutter assembly 16 with the fasteners 88 removed from the lower housing shell section 18, but with the retention plate 86 intact. FIG. 25 depicts the foil cutter assembly 16 with the retention plate 86 removed from the lower housing shell section 18. This exposes a foil cutting blade 90 and a spring 92 that may be implemented as a coil compression spring or any other flexible resilient member having a suitable spring constant (such as a bendable plastic member formed as part of the thumb-engaging member 14 to form an integrated spring).

FIGS. 26, 27 and 28 depict the foil cutter assembly 16 in further stages of disassembly so that the arrangement of the thumb-engaging member 14, the foil cutting blade 90, and the spring 92 can be clearly seen. As shown in FIG. 26, the lower housing shell section 18 is formed with a cutter guide track 94 that slidably retains the foil cutting blade 90. The cutter guide track 94 is located behind the thumb-engaging edge portion 6, proximate to the foil-dispensing portion 10 of the housing 4. At the lower end of the cutter guide track 94, a small cutter-exit slot 96 is formed in the horizontal ledge 50 of the housing 4. The cutter-exit slot 96 provides an opening for the foil-cutting element 90 to advance out of the housing 4. At the upper end of the cutter guide track 94, an access window 98 is formed in the thumb-engaging edge portion 6. The access window 98 allows exterior elements of the thumb-engaging member 14 to interconnect with interior elements thereof. In particular, an exterior thumb-engaging element 14A of the thumb-engaging member 14, disposed on the outside of the thumb-engaging edge portion 6, interconnects to an interior cutter-driving element 14B of the thumb-engaging member 14, disposed within the cutter guide track 94.

Located behind the cutter guide track 94 is a spring-holding chamber 100 in which the spring 92 is disposed. An upper portion of the spring-holding chamber 100 that lies above the spring 92 opens to both the cutter guide track 94 and the access window 98. This provides a passageway that allows an interior spring-engaging element 14C of the thumb-engaging member 14 to pass through the access window 98 and the cutter guide track 94, and enter the spring-holding chamber 100 in order to engage the spring 92. This passageway is shown by reference number 102 in FIG. 27. As additionally shown in FIG. 27, the spring-engaging element 14C of the thumb-engaging member 14 may include a small cylindrical post that inserts into the center of the spring 92 in order to affirmatively engage the spring. As shown in FIG. 28, the foil-cutting element 90 is disposed in a narrow slot formed by the gap between the exterior thumb-engaging element 14A and the interior cutter-driving element 14B of the thumb-engaging member 14. This arrangement affixes the foil-cutting element 90 to the thumb-engaging member 14 for movement therewith.

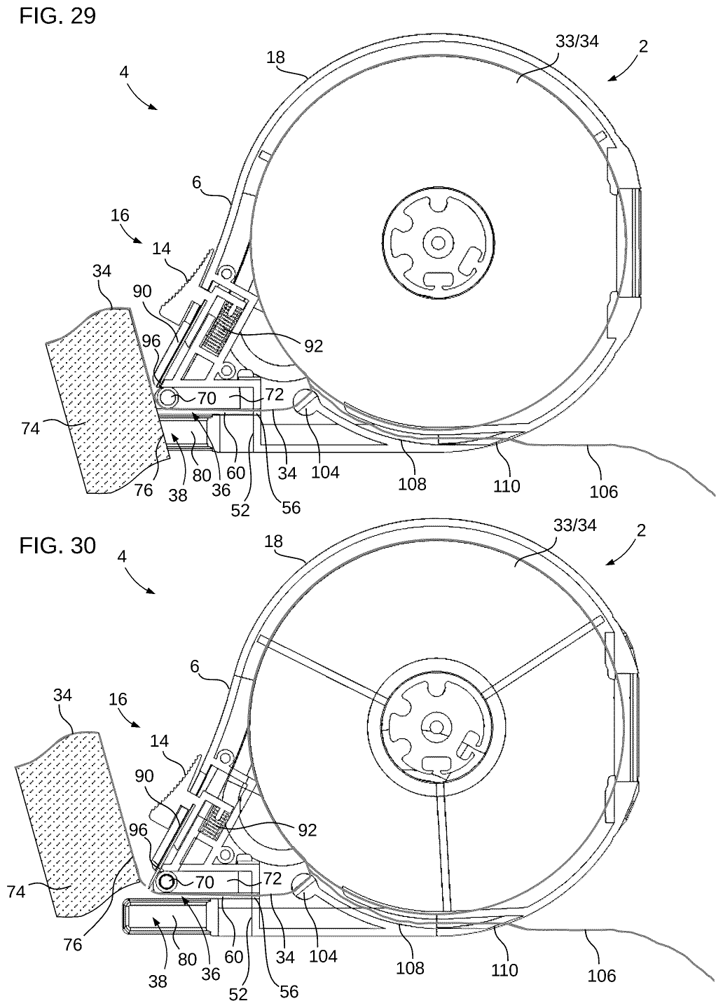

Turning now to FIGS. 29-30, the cutting element 90 is thus operably connected to the thumb-engaging member 14 so as to be drivable thereby from a retracted position to an extended position wherein the cutting element engages the metallic foil material 34 as it dispenses from the foil dispenser 36. The spring 92 biases the thumb-engaging member to its retracted position, which is shown in FIG. 29. FIG. 29 additionally depicts part of a foiling operation previously depicted in FIGS. 20-21 in which metallic foil material 34 is applied to the edge 76 of a piece of glass 74. In FIG. 29, the glass 74 is slidably disposed within the glass alignment guide 38 while the metallic foil material 34 is applied to the glass edge 76 by the foil dispenser 36.

With continuing reference to FIGS. 29-30, the metallic foil material 34 emanates from the foil roll 33 disposed within the housing 4. As previously described, the foil roll 33 may be carried on a roll-holding hub (reference number 32A in FIGS. 8-11) formed within the lower housing shell section 18. Upon leaving the foil roll 33, the metallic foil material 34 feeds through a foil material backing peeler 104 that is also formed within the lower housing shell section 18. The backing peeler 104 separates an adhesive backing 106 from the metallic foil material 34, and directs the backing material along a waste track 108 to a waste exit 110 of the housing 4. The waste track 108 and the waste exit 110 are also formed within the lower housing shell section 18.

As the metallic foil material 34 exits the backing peeler 104, it passes out of the lower housing shell section 18 (and the housing 4 itself) via the horizontal foil dispenser slot 56 formed in the vertical ledge 52 of the foil-dispensing portion 10 of the housing 4. The metallic foil material 34 then enters the horizontal slot 60 of the foil dispenser 36 and the non-adhesive side (upper side in FIGS. 29-30) of the foil material passes under the foil dispenser roller 70 in the foil-dispensing direction “FDD” and onto the glass edge 76. This allows the adhesive side of the metallic foil material 34 to be applied to the glass edge 76. Once a desired amount of the metallic foil 34 has been applied to the glass edge 76, the foil material is cut by manipulating the thumb-engaging member 14 of the foil cutter assembly 16.

The metallic foil cutting operation is shown in FIG. 30. The foil cutting blade 90 extends in a direction that is substantially parallel to the thumb-engaging edge portion 6 of the housing 4. As previously noted, the thumb-engaging edge portion 6 converges toward the finger-engaging edge portion 8 of the housing 4, which is parallel to the foil dispensing direction “FDD” of the foiler apparatus 2. By advancing the foil cutting blade 90, the latter will thus intersect the foil dispensing pathway by which the metallic foil material 34 exits the foil dispenser 36. The foil cutting blade 90 passes through the cutter-exit slot 96 formed in the lower housing shell section 18, and engages the metallic foil material 34 proximate to a downstream side of the foil-dispensing roller 70, thereby cutting it. Once the cutting is done, the thumb-engaging member 14 is released, and the foil cutting blade 90 is retracted back into the lower housing shell section 18 by virtue of the spring 92 driving against the spring-engaging element 14C of the thumb-engaging member 14.

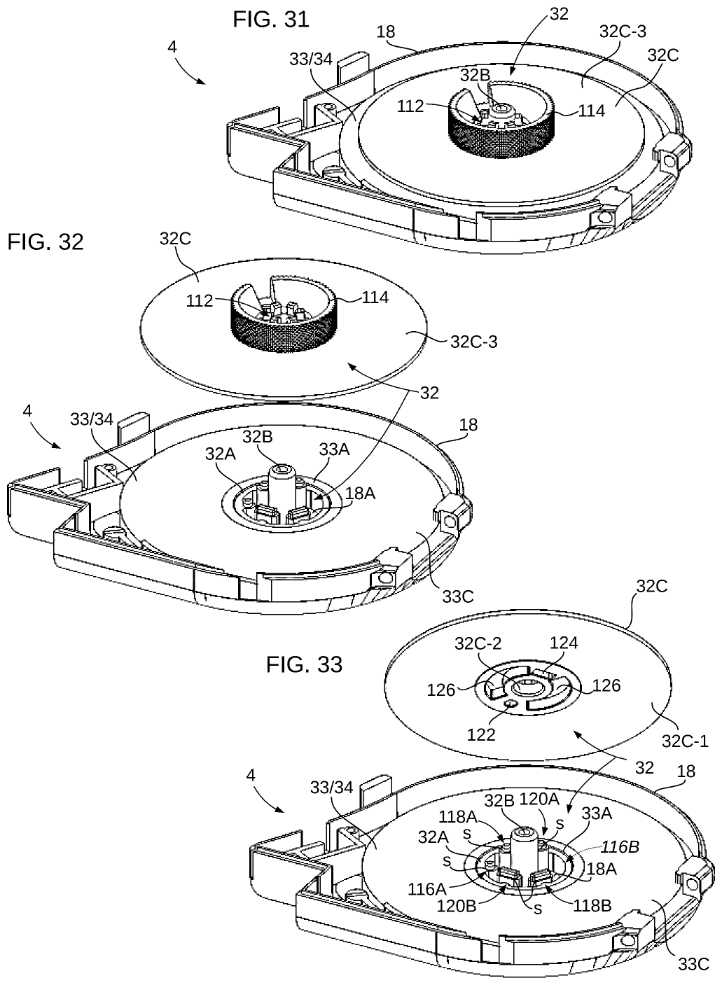

Turning now to FIGS. 31-33, the operation of the adjustable foil holder assembly 32 will now be described. As previously noted, the adjustable foil holder assembly 32 is selectively adjustable in order to hold different rolls 33 of metallic foil material 34 having different foil widths. For example, the adjustable foil holder assembly 32 may be configured to selectively accommodate rolls of copper foil in three widths: 3/16 in. (4.763 mm); 7/32 in. (5.556 mm); and ¼ in. (6.350 mm).

As discussed above in connection with FIGS. 7-11, the adjustable foil assembly 32 may be implemented as a multi-component assembly that includes a roll-holding hub 32A, a spindle 32B, and a rotatably positionable set disk 32C. The roll-holding hub 32A extends from an inside surface 18A of the lower housing shell section 18 (see FIGS. 32-33) and engages a central core ring 33A in the roll 33 of metallic foil material 34, entering from a lower side of the roll. The spindle 32B extends from the same inside surface 18A of the lower housing shell section 18, and passes through and beyond the central core ring 33A in the roll 33 of metallic foil material 34. As best shown in FIG. 33, the set disk 32C includes a central spindle-receiving opening 32C-2 that receives the spindle 32B when the lower face 32C-1 of the set disk engages the upper side 33C of the roll 33 of metallic foil material 34. As best shown in FIGS. 31-32, a second upper face 32C-3 of the set disk 32C includes spindle gripping members 112 that releasably grip the spindle 32B when the set disk 32C engages the roll 33 of metallic foil 34. Also disposed on the second face 32C-3 of the set disk 32C is a circular grasping member 114 whose exterior surface may be knurled for grasping the set disk and rotating it between different rotational positions.

The set disk 32C is rotatably positionable between at least two different positions corresponding to at least two different widths of the roll 33 of metallic foil material 34. The rotational positions of the set disk 32C are established by various standoffs that extend from the inside surface 18A of the lower housing shell section 18. FIGS. 32 and 33 depict five such standoffs labeled 116A, 118A, 118B, 120A and 120B (plus a “virtual” standoff 116B described in more detail below). The standoffs 116A, 118A, 118B, 120A and 120B have characteristic lengths that correspond to the characteristic widths of different rolls 33 of metallic foil 34. The lower side 32C-1 of the set disk 32C is formed with standoff-engaging recesses 122 and 124 that selectively accept different ones of the standoffs 116A, 118A, 118B, 120A and 120B to a depth that allows the set disk to engage the roll 33 of metallic foil material 34 while accommodating its width.

The depth to which the standoffs 116A, 118A, 118B, 120A and 120B will insert into the standoff-engaging recesses 122 and 124 is controlled by the configuration of the standoffs. As can be seen in FIG. 33, each of the standoffs 116A, 118A, 118B, 120A and 120B is formed with a laterally-protruding set-disk support shoulder “s” situated slightly below the terminal upper end of the standoff. The shoulder “s” engages the lower side 32C-1 of the set disk 32C when the terminal end of the standoff inserts into one of the standoff-engaging recesses 122 and 124.

Standoffs having the same shoulder height are disposed diametrically across from each other on opposite sides of the spindle 32B. Thus, standoff's 118A/118B have one characteristic shoulder height, and standoff's 120A/120B have another characteristic shoulder height. Standoff 116A also has a characteristic shoulder height, but does not require a diametrically-opposed counterpart standoff because its shoulder “s” is at the same height as the top of the roll-holding hub 32A. The top portion of the roll-holding hub 32A that is situated in diametric opposition to the standoff 116A may thus be thought of as a “virtual” standoff having a virtual shoulder height “s.” This virtual standoff is shown by reference number 116B in FIG. 33.

The standoff-engaging recesses 122 and 124 on the set disk 32C are disposed diametrically across from each other on opposite sides of the spindle-receiving opening 32C-2. The standoff-receiving recesses 122 and 124 are arranged to engage different pairs of standoffs having the same shoulder height by rotating the set disk between different rotational positions. To help guide the set disk 32C into rotational registration with a desired pair of standoffs, each pair of standoffs having the same shoulder height “s” may include a first standoff of cylindrical shape (e.g., standoffs 116A, 118A and 120A), and a second standoff of rectangular (e.g., standoffs 118B and 120B). The standoff-engaging recesses 122 and 124 on the set disk 32C are correspondingly configured with either a cylindrical shape or a rectangular shape in order to restrict their engagement to certain ones of the standoffs. In particular, standoff-engaging recess 122 has a circular shape that engages only the cylindrical standoffs 116A, 118A and 120A, whereas standoff-engaging recess 124 has a rectangular shape that engages only the rectangular standoffs 118B and 120B (or will lie above the virtual standoff 116B without restriction). If desired, the set disk 32C may include arcuate standoff clearance channels 126 that receive (without engaging) the standoffs that are not engaged by the standoff-engaging recesses 122 and 124.

As previously noted, the standoff 116A has a set-disk support shoulder “s” that is even with the top of the roll-holding hub 32A, a portion of which provides the virtual standoff 116B. This first pair of standoffs 116A/116B is provided for metallic foil rolls 33 of minimum width, such as a roll of copper foil whose foil width is 3/16 in. (4.763 mm).

As previously noted, the standoffs 118A and 118B likewise have set-disk support shoulders “s” of equal height, and this shoulder height is higher than the shoulder height of the standoff 116A and its virtual counterpart 116B. This second pair of standoffs 118A/118B is provided for metallic foil rolls 33 of medium width, such as a roll of copper foil whose foil width is 7/32 in. (5.556 mm).

As additionally previously noted, the standoffs 120A and 120B also have set-disk support shoulders “s” of equal height, and this shoulder height is higher than the shoulder height of the standoffs 118A and 118B. This third pair of standoffs 120A/120B is provided for metallic foil rolls 33 of maximum width, such as a roll of copper foil whose foil width is ¼ in. (6.350 mm).

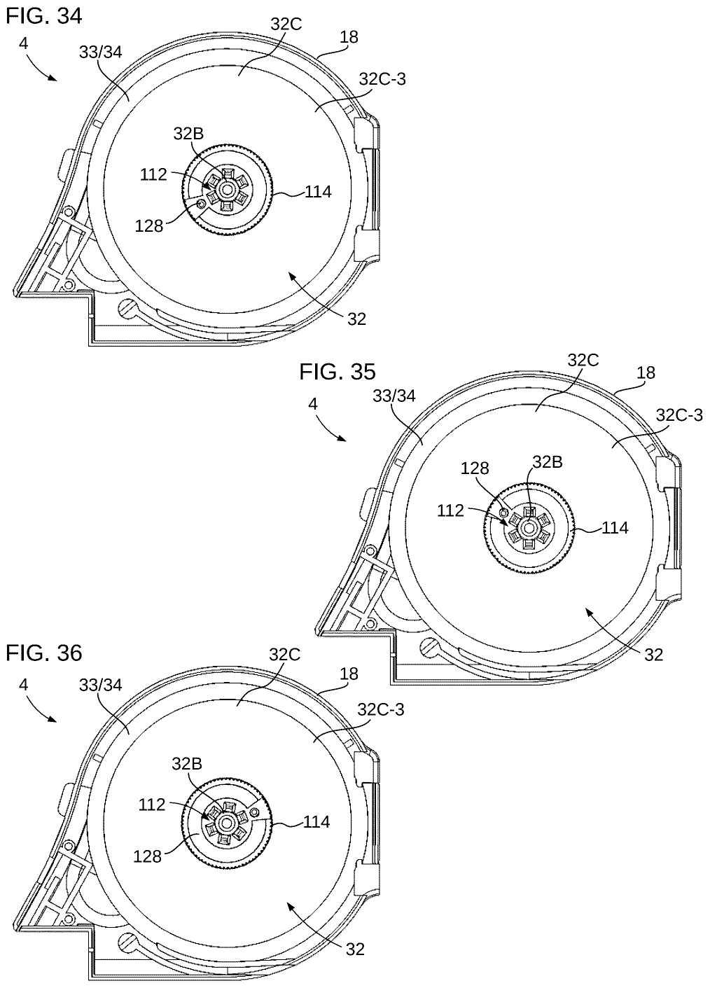

The set disk 32C can be lifted off the spindle 32B and rotated according to the width of the roll 33 of metallic foil 34 being used in the foiler apparatus 2. FIGS. 34-36 illustrate example rotational positions of the set disk 32C. FIG. 34 shows the set disk 32C positioned to engage the standoff pair 116A/116B for securing a minimum width foil roll 33. FIG. 35 shows the set disk 32C positioned to engage the standoff pair 118A/118B for securing a medium width foil roll 33. FIG. 36 shows the set disk 32C positioned to engage the standoff pair 120A/120B for securing a maximum width foil roll 33.

As shown in FIGS. 34-36, the set disk 32C may be formed with a view port 128 extending through one of the standoff-engaging recesses, such as the circular standoff-engaging recess 122. The view port 128 facilitates alignment of the standoff-engaging recess 122 with the circular standoffs 116A, 118A and 120A. The circular standoffs 116A, 118A and 120A may themselves be uniquely color-coded at a location whereby the color-code (e.g., their terminal upper ends) can be discerned through the set disk view port 128.

If desired, the central core ring 33A of the roll 33 of metallic foil material 34 (see FIG. 32) may also be color-coded to assist the user in choosing a foil roll having a particular width. For example, the central core ring 33A of a copper foil roll whose foil width is 3/16 in. (4.763 mm) may have a first color (e.g., orange), the central core ring of a copper foil roll whose foil width is 7/32 in. (5.556 mm) may have a second color (e.g., green), and the central core ring of a copper foil roll whose foil width is ¼ in. (6.350 mm) may have a third color (e.g., white). Associating specific colors with specific metallic foil widths will create color “memory” that trains users of the foiler apparatus 2 to easily recognize metallic foil rolls 33 having different foil widths.

It will be further appreciated that the dispenser-guide-crimper assemblies 12A, 12B and 12C of FIGS. 22A, 22B and 22C may also be color-coded in the same manner. This allows the appropriate dispenser-guide-crimper assembly 12A, 12B or 12C to be selected by matching its color to the color of the central core ring 33A of the roll 33 of metallic foil material 34 whose width corresponds to the design width of the dispenser-guide-crimper.

In addition to color coding the central core ring 33A of the roll 33 of metallic foil material 34, the core ring may also be sized in an advantageous manner. For example, recalling that the foiler apparatus 2 is configured as a handheld device that can be operated with one hand, the outside diameter of the metallic foil roll 33 may be approximately 2.75-3.75 inches for all widths of the metallic foil 34. In order to maximize the amount of metallic foil 34 that can be carried on a single foil roll 33, the central core ring 33A can be made smaller than the cores found in conventional metallic foil rolls used for foiling glass. Thus, whereas a typical metallic foil roll core is 3 inches in diameter, the central core ring 33A may have an outside diameter of approximately 1 inch or less.

To use of the foiler apparatus 2, a user may grasp the apparatus by placing a thumb on the thumb-receiving edge portion 6 of the housing 4, and the remaining fingers on the finger-receiving edge portion 8 of the housing. With the metallic foil material 34 feeding through the slot 60 of the foil dispenser and underneath the foil-dispensing roller 70, the edge 76 of a piece of glass 74 to be foiled may be inserted into the alignment slot 78 of the glass alignment guide 38. The free end of the metallic foil material 34 that extends from the foil dispenser 36 may be placed onto the glass edge, with the adhesive side of the foil material being adhered thereto. The glass alignment guide 38 and the glass edge 76 may be slid relative to each other so that additional metallic foil material 34 is dispensed from the foil dispenser 36 and onto the glass edge. This may be accomplished by holding the glass 74 stationary while the glass foiler apparatus 2 is moved, or by holding the glass foiler apparatus stationary and moving the glass, or by moving both simultaneously. Once a desired amount of the glass edge 76 has been covered with the metallic foil material 34, the foil may be cut by advancing the slidable thumb-engaging member 14 so as to drive the foil cutting blade 90 to its extended position. The metallic foil material 34 may now be crimped by placing the glass edge 76 that is covered with the metallic foil material into the foil crimping slot 82 of the foil crimper 40, and sliding the crimper and the glass edge relative to each other. Again, this may be accomplished by holding the glass 74 stationary while the glass foiler apparatus 2 is moved, or by holding the glass foiler apparatus stationary and moving the glass, or by moving both simultaneously.

Accordingly, embodiments of a handheld glass foiler apparatus and related method have been disclosed. Reference in the present disclosure to an “embodiment” means that a particular feature, structure or characteristic described in connection with the embodiment may be included in at least one embodiment of the disclosed device. Thus, the appearances of the term “embodiment” in various places throughout the specification are not necessarily all referring to the same embodiment.

For purposes of explanation, specific configurations and details have been set forth herein in order to provide a thorough understanding of the present invention. However, it will be apparent to one of ordinary skill in the art that embodiments of the present invention may be practiced without the specific details presented herein. Furthermore, well-known features may have been omitted or simplified in order not to obscure the present invention. Various examples have been given throughout this description. These examples are merely descriptions of specific embodiments of the invention. The scope of the claimed subject matter is not limited to the examples given.

As used herein, the terms such as “upper,” “lower,” “top,” “bottom,” “vertical,” “vertically,” “lateral,” “laterally,” “inner,” “outer,” “outward,” “inward,” “front,” “frontward,” “forward,” “rear,” “rearward,” “upwardly,” “downwardly,” “inside,” “outside,” “interior,” “exterior,” and other orientational descriptors are intended to facilitate the description of the example embodiments of the present disclosure dispenser e, and are not intended to limit the structure of the example embodiments of the present disclosure to any particular position or orientation. Terms of degree, such as “substantially” or “approximately” are understood by those of ordinary skill to refer to reasonable ranges outside of the given value, for example, general tolerances associated with manufacturing, assembly, and use of the described embodiments. Terms of rough approximation, such as “generally,” are understood by those of ordinary skill to refer to a characteristic or feature of that bears resemblance to something, such that it is reasonable to draw a comparison to facilitate understanding, without requiring that the characteristic or feature be exactly the same, or even substantially the same, as the thing to which it is compared.

All of the drawing figures and examples herein are intended to be non-limiting. They merely represent examples of how the inventive subject matter recited in the claims appended hereto may be implemented in practice. Modifications to the configuration and arrangement of components, assemblies and operations of the apparatus and methodologies disclosed herein may be implemented without departing from the spirit and scope of the invention. Thus, although example embodiments have been shown and described, it should be apparent that many variations and alternate embodiments could be implemented in accordance with the present disclosure. It is understood, therefore, that the invention is not to be limited except in accordance with the appended claims and equivalents thereof.

1-20. (canceled)

21. A handheld glass foiler apparatus, comprising:
a housing sized to be held by a human hand, the housing comprising a thumb-receiving edge portion arranged to engage a thumb of the human hand, a finger-receiving edge portion arranged to engage the remaining fingers of the human hand, and a foil-dispensing portion;
a hub within the housing arranged to mount a roll of flexible metallic foil material to be dispensed out of the housing from the foil-dispensing portion of the housing; and
a foil material backing peeler that separates an adhesive backing from the metallic foil material within the housing and directs the adhesive backing along a waste track to a waste exit of the housing.

22. The glass foiler apparatus of claim 21, wherein the thumb-receiving edge portion of the housing and the finger-receiving edge portion of the housing converge toward each other to the foil-dispensing portion of the housing.

23. The glass foiler apparatus of claim 21, further including a foil dispenser disposed on the foil-dispensing portion of the housing, the foil dispenser being configured to dispense metallic foil material out of the housing, the foil dispenser having a characteristic dispenser width corresponding to a characteristic width of the foil material.

24. The glass foiler apparatus of claim 23, further including a glass alignment guide disposed on the foil-dispensing portion of the housing, the glass alignment guide being configured to slidably engage a glass edge as the metallic foil material dispensed from the foil dispenser is being applied to the edge.

25. The glass foiler apparatus of claim 24, further including a foil crimper disposed on the foil-dispensing portion of the housing, the foil crimper being configured to slidably engage a glass edge to which the metallic foil has been applied and crimp the metallic foil so that it wraps around the glass edge onto adjacent major surfaces of the glass.

26. The glass foiler apparatus of claim 25, wherein the foil dispenser, the glass alignment guide and the foil crimper are part of a dispenser-guide-crimper assembly.

27. The glass foiler apparatus of claim 26, wherein the dispenser-guide-crimper assembly is removably attached as a unit to the foil-dispensing portion of the housing and is color-coded according to a characteristic width of the metallic foil material.

28. The glass foiler apparatus of claim 21, further including a foil cutter comprising a slidable thumb-engaging member on the thumb-engaging edge portion of the housing and a cutting element operably connected to the thumb-engaging member so as to be drivable thereby from a retracted position to an extended position wherein the cutting element engages a metallic foil material as it dispenses from the foil-dispensing portion of the housing.

29. The glass foiler apparatus of claim 21, further including an adjustable foil holder comprising a spindle on an inside surface of the housing arranged to extend through a central opening in a roll of metallic foil mounted on the hub from a first side of the roll, and a positionable set disk having a central opening that receives the spindle and a first face that engages a second side of the roll.

30. The glass foiler apparatus of claim 29, wherein the set disk is positionable between at least two different positions corresponding to at least two different widths of the roll of metallic foil.

31. The glass foiler apparatus of claim 30, wherein the set disk is positionable by virtue of engaging different pairs of standoffs extending from the inside surface of the housing, each pair of standoffs having a different length uniquely corresponding to a characteristic width of the roll of metallic foil.

32. The glass foiler apparatus of claim 31, wherein the set disk comprises standoff-engaging recesses that selectively engage the different pairs of standoffs to a depth that allows the set disk to engage the roll of metallic foil while accommodating its width.

33. The glass foiler apparatus of claim 32, wherein the standoffs forming each pair of standoffs are disposed diametrically on opposite sides of the spindle, and wherein standoff-engaging recesses are arranged on the set disk to engage the different pairs of standoffs by rotating the set disk between different rotational positions.

34. The glass foiler apparatus of claim 33, wherein the set disk comprises standoff clearance channels that receive without engaging one or more pairs of standoffs that are not engaged by the standoff-engaging recesses.

35. The glass foiler apparatus of claim 34, wherein the set disk comprises spindle gripping members that releasably grip the spindle when the set disk engages the roll of metallic foil.

36. The glass foiler apparatus of claim 35, wherein the set disk comprises a second face on which is disposed a grasping member for grasping the set disk and rotating it between its different rotational positions.

37. The glass foiler apparatus of claim 36, wherein the set disk is formed with a view port extending through one of the standoff-engaging recesses, the view port facilitating alignment of the standoff-engaging recess with the standoffs, and wherein at least some of the standoffs are uniquely color-coded at a location whereby the color-code can be discerned through the set disk view port.

38. A handheld glass foiler apparatus, comprising:
a housing sized to be held by a human hand, the housing comprising a thumb-receiving edge portion arranged to engage a thumb of the human hand, a finger-receiving edge portion arranged to engage the remaining fingers of the human hand, and a foil-dispensing portion;
a roll of flexible metallic foil material mounted on a hub within the housing;
a foil dispenser, a glass alignment guide and a foil crimper disposed on the foil-dispensing portion of the housing;
the foil dispenser being configured to dispense the metallic foil material, the foil dispenser comprising a foil-dispensing roller having a characteristic length corresponding to a characteristic width of the metallic foil material;
the glass alignment guide being configured to slidably engage a glass edge as the metallic foil material dispensed from the foil dispenser is being applied to the edge, the glass alignment guide comprising a slot having a characteristic slot width that accommodates a characteristic range of glass thicknesses;
the foil crimper being configured to slidably engage a glass edge to which the metallic foil has been applied and crimp the metallic foil so that it wraps around the glass edge onto adjacent major surfaces of the glass, the foil crimper comprising a slot having a characteristic width that accommodates a characteristic range of glass thicknesses; foil-dispensing portion of the housing
a foil cutter comprising a slidable thumb-engaging member on the thumb-engaging edge portion of the housing, and a cutting element operably connected to the thumb-engaging member so as to be drivable thereby from a retracted position to an extended position wherein the cutting element engages the metallic foil material as it dispenses from the foil dispenser portion of the housing;
an adjustable foil holder within the housing configured to hold the roll of metallic foil material, the foil holder being adjustable to hold different rolls of metallic foil material having different foil widths; and
a foil material backing peeler that separates an adhesive backing from the foil material within the housing and directs the adhesive backing along a waste track to a waste exit of the housing.

39. A glass foiling method using the handheld glass foiler apparatus of claim 38, comprising:
grasping the glass foiler apparatus by placing a thumb on the thumb-receiving edge portion of the housing and the remaining fingers on the finger-receiving edge portion of the housing;
inserting a glass edge into the glass alignment guide;
placing an end of the metallic foil material that extends from the foil dispensing-portion onto the glass edge;
sliding the glass alignment guide and the glass edge relative to each other so that additional metallic foil material is dispensed from the foil dispenser and onto the glass edge;
cutting the metallic foil by advancing the slidable thumb-engaging member of the foil cutter to drive the cutting element to its extended position when a desired amount of the glass edge is covered with the metallic foil material; and
crimping the metallic foil material by placing the glass edge that is covered with the metallic foil material into the foil crimper and sliding the crimper and the glass edge relative to each other.

40. A handheld glass foiler apparatus, comprising:
a housing sized to be held by a human hand, the housing comprising a thumb-receiving edge portion arranged to engage a thumb of the human hand, and a finger-receiving edge portion arranged to engage the remaining fingers of the human hand, the thumb-receiving edge portion and the finger-receiving edge portion converging toward each other to a foil-dispensing portion of the housing;
the housing comprising a first housing shell section and a second housing shell section joined at a part line extending around an edge of the housing that includes the thumb-receiving edge portion and the finger-receiving edge portion, the first housing shell section and the second housing shell section being pivotally connected to each other to facilitate opening and closing of the housing to access an interior thereof;
a roll of flexible metallic foil material mounted on a hub within the housing, the roll of metallic foil material having a central core ring that mounts on the hub, the central core ring being color-coded according to a width of the metallic foil material;
an adjustable foil holder within the housing configured to hold the roll of metallic foil material, the foil holder being adjustable to hold different rolls of metallic foil material having different foil widths and having central core rings that are color-coded according to the foil width;
the adjustable foil holder comprising a spindle on an inside surface of the housing that extends through a central opening in the roll of metallic foil from a first side of the roll, and a positionable set disk having a central opening that receives the spindle and a first face that engages a second side of the roll;
the set disk being positionable between at least two different positions corresponding to at least two different widths of the roll of metallic foil;
the set disk being positionable by virtue of engaging different pairs of standoffs extending from the inside surface of the housing, each pair of standoffs having a different length uniquely corresponding to a characteristic width of the roll of metallic foil;
the set disk comprising standoff-engaging recesses that selectively engage the different pairs of standoffs to a depth that allows the set disk to engage the roll of metallic foil while accommodating its width;
the standoffs forming each pair of standoffs being disposed diametrically on opposite sides of the spindle, and the standoff-engaging recesses being arranged on the set disk to engage the different pairs of standoffs by rotating the set disk between different rotational positions;
the set disk comprising standoff clearance channels that receive without engaging one or more pairs of standoffs that are not engaged by the standoff-engaging recesses;
the set disk comprising spindle gripping members that releasably grip the spindle when the set disk engages the roll of metallic foil;
the set disk comprising a second face on which is disposed a grasping member for grasping the set disk and rotating it between its different rotational positions;
the set disk being formed with a view port extending through one of the standoff-engaging recesses, the view port facilitating alignment of the standoff-engaging recess with the standoffs, and at least some of the standoffs being uniquely color-coded at a location whereby the color-code can be discerned through the set disk view port;
a dispenser-guide-crimper assembly comprising a foil dispenser, a glass alignment guide and a foil crimper, the dispenser-guide-crimper assembly being removably attached as a unit to the foil-dispensing portion of the housing and being color-coded to match the color coding of the central core ring of the metallic foil roll;
the foil dispenser of the dispenser-guide-crimper assembly being configured to dispense the metallic foil material from a selected one of the different rolls of metallic foil material, the foil dispenser comprising a foil-dispensing roller having a characteristic length corresponding to a characteristic width of the foil material on the selected roll of metallic foil material;
the foil dispenser being configured to dispense the metallic foil material in a foil-dispensing direction that extends substantially parallel to the finger-engaging edge portion of the housing;
the glass alignment guide of the dispenser-guide-crimper assembly being configured to slidably engage a glass edge as the metallic foil material dispensed from the foil dispenser is being applied to the edge, the glass alignment guide comprising a slot having a characteristic slot width that accommodates a characteristic range of glass thicknesses;
the foil crimper of the dispenser-guide-crimper assembly being configured to slidably engage a glass edge to which the metallic foil has been applied and crimp the metallic foil so that it wraps around the glass edge onto adjacent major surfaces of the glass, the foil crimper comprising a slot having a characteristic width that accommodates a characteristic range of glass thicknesses;
the foil crimper slot being substantially parallel to the glass alignment guide slot, and both being substantially parallel to a foil-dispensing direction of the foil dispenser;
a foil cutter comprising a slidable thumb-engaging member on the thumb-engaging edge portion of the housing, and a cutting element operably connected to the thumb-engaging member so as to be drivable thereby from a retracted position to an extended position wherein the cutting element engages the metallic foil as it dispenses from the foil dispenser;
the foil cutter comprising a spring that biases the thumb-engaging member to its retracted position;
the foil cutter cutting element extending in a direction that is substantially parallel to the thumb-engaging edge portion of the housing, and engaging the metallic foil proximate to a downstream side of the foil dispenser's foil-dispensing roller; and
a foil material backing peeler that separates an adhesive backing from the foil material within the housing and directs the adhesive backing along a waste track to a waste exit of the housing.
